(19) United States
(12) Patent Application Publication
(10) Pub. No.: US 2024/0325961 A1
(43) Pub. Date: Oct. 3, 2024

(54) CHARGING DEVICE

(71) Applicant: THE UNIVERSITY OF TOKYO, Tokyo (JP)

(72) Inventors: Kaori SUGIHARA, Tokyo (JP); Miles PENNINGTON, Tokyo (JP); Taisuke IKAWA, Tokyo (JP); Shoki TANIURA, Tokyo (JP); Muhang LI, Tokyo (JP); Shota KIUCHI, Tokyo (JP)

(21) Appl. No.: 18/737,094

(22) Filed: Jun. 7, 2024

Related U.S. Application Data
(63) Continuation of application No. PCT/JP2022/044754, filed on Dec. 5, 2022.

(30) Foreign Application Priority Data
Dec. 14, 2021 (JP) 2021-202761

(51) Int. Cl. B01D 46/66; A41D 13/11

(52) U.S. Cl. CPC B01D 46/785; A41D 13/11

(57) ABSTRACT

A charging device includes a charger on which an object is placed, and an output circuit structured to boost a voltage and output an output voltage. The charger charges the placed object in a state of being charged by the output voltage outputted from the output circuit.

### CROSS REFERENCE TO RELATED APPLICATIONS

This application is a continuation under 35 U.S.C. § 120 of PCT/JP2022/044754, filed Dec. 5, 2022, which is incorporated herein by reference, and which claimed priority to Japanese Application No. 2021-202761, filed Dec. 14, 2021. The present application likewise claims priority under 35 U.S.C. § 119 to Japanese Application No. 2021-202761, filed Dec. 14, 2021, the entire content of which is also incorporated herein by reference.

### BACKGROUND

### 1. Technical Field

The present disclosure relates to a charging device.

### 2. Description of the Related Art

In recent years, a mask provided with holes each having a size of 10 μm or less is used by medical workers who treat patients, for example, those infected with corona viruses. Static electricity is applied to this mask, and aerosols can be captured in the holes of the mask by the static electricity (H. Ding, Proc. SPIE, 1991, 1519, 847-856).

However, when the mask is cleaned by alcohol or the like in order to reuse the mask, static electricity which has been applied to the mask decreases. Therefore, a technique capable of applying static electricity to the mask again after cleaning is desired.

### SUMMARY

The present disclosure has been made in view of such a situation, and one exemplary object thereof is to provide a charging device capable of easily charging various objects.

A charging device according to one aspect of the present disclosure comprises a charger on which an object is placed, and an output circuit that boosts a voltage and outputs an output voltage, and the charger charges the object placed in a state of being charged by the output voltage outputted from the output circuit.

Note that arbitrary combinations of the abovementioned components and transformation of expressions in the present disclosure into a method, a system, or the like are also effective as aspects of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic configuration diagram of a charging device according to one embodiment of the present disclosure,

FIG. 2 is a diagram for explaining a measurement condition in Experiment 1,

FIG. 3 is a diagram for explaining a measurement condition in Experiment 1,

FIG. 4 is a diagram illustrating a configuration of a flat plate used in Experiment 1,

FIG. 5 is a diagram illustrating a position where a charged voltage of the flat plate in a charged state is measured in Experiment 1,

FIG. 6 is a graph illustrating measurement results in Experiment 1,

FIG. 7 is a diagram for explaining a measurement condition in Experiment 2,

FIG. 8 is a diagram for explaining a measurement condition in Experiment 2;

FIG. 9 is a graph illustrating measurement results in Experiment 2,

FIG. 10 is a circuit diagram illustrating an output circuit included in an electrostatic gun, FIG. 11 is a diagram for explaining a measurement condition in Experiment 3,

FIG. 12 is a graph illustrating measurement results in Experiment 3,

FIG. 13 is a diagram illustrating measurement results in Experiment 4,

FIG. 14 is a diagram illustrating a position where a charged voltage is measured in Experiment 5,

FIG. 15A is a diagram illustrating a lid used in Experiment 5,

FIG. 15B is a diagram illustrating a lid used in Experiment 5,

FIG. 15C is a diagram illustrating a lid used in Experiment 5,

FIG. 16 is a graph illustrating measurement results in Experiment 5,

FIG. 17 is a diagram for explaining an experimental condition in Experiment 6,

FIG. 18A is a diagram for explaining the first lid condition in Experiment 6,

FIG. 18B is a diagram for explaining the second lid condition in Experiment 6,

FIG. 18C is a diagram for explaining the third lid condition in Experiment 6,

FIG. 19 is a diagram illustrating measurement results according to the lid conditions,

FIG. 20 is an exterior drawing of a charging device according to one embodiment of the present disclosure,

FIG. 21 is a diagram illustrating one example of a state where the charging device according to the present embodiment is in use,

FIG. 22 is a block diagram for explaining functions of the charging device according to the present embodiment,

FIG. 23 is an exterior drawing of a charging device according to a modification; and

FIG. 24 is a drawing illustrating a state where the charging device according to the modification is opened.

### DETAILED DESCRIPTION

The disclosure will now be described by reference to the preferred embodiments. This does not intend to limit the scope of the present invention, but to exemplify the invention. Note that, in the description of the drawings, the same elements are denoted by the same reference numerals, and redundant description thereof will be omitted as appropriate.

### Charging Device

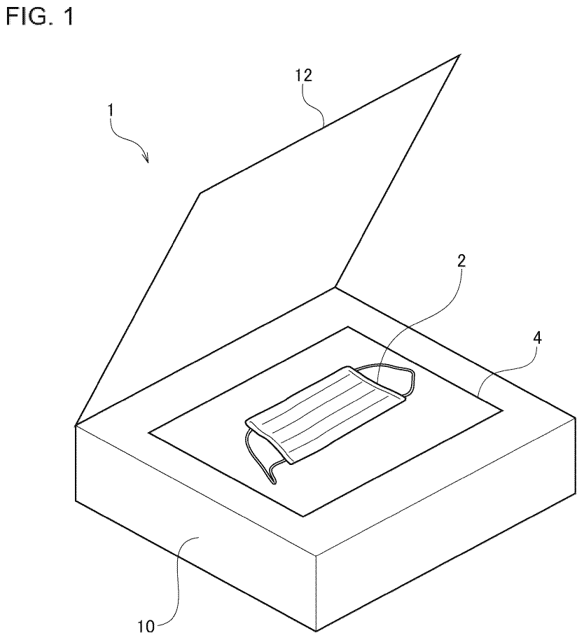

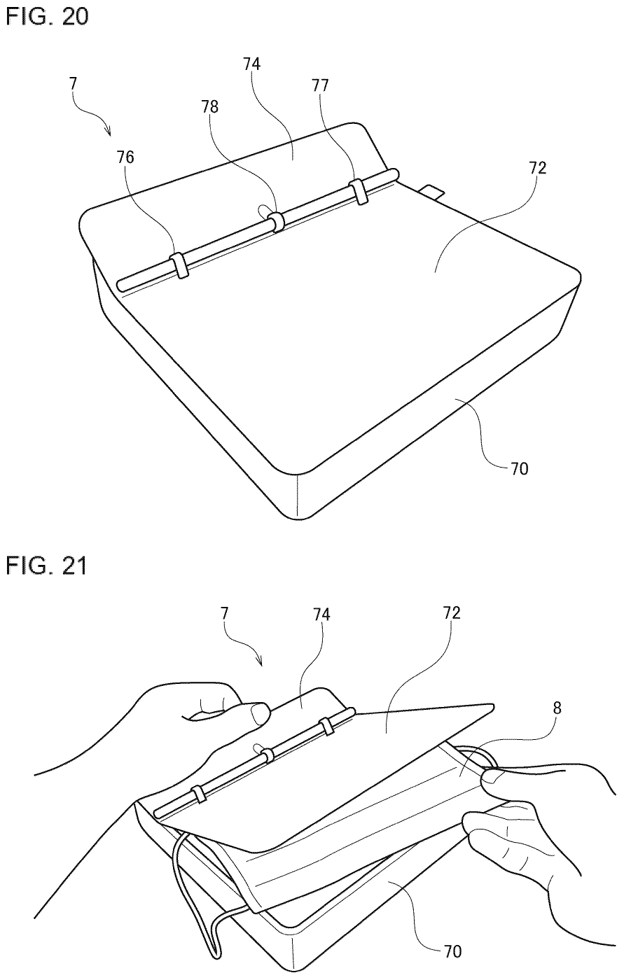

FIG. 1 is a schematic configuration diagram of a charging device 1 according to one embodiment of the present disclosure. The charging device 1 is a device for charging various objects. A detailed configuration of the charging device 1 will be described later with reference to FIGS. 20 to 22. Here, an outline of the configuration of the charging device 1 is explained.

As illustrated in FIG. 1, the charging device 1 includes a housing 10 and a lid portion 12. The lid portion 12 is rotatably connected to the housing 10. A flat plate 4 is disposed on the upper surface of the housing 10. A gap may be formed between the flat plate 4 and the housing 10 such that the flat plate 4 does not directly contact the housing 10. This flat plate 4 is electrically connected to an output circuit (not illustrated in FIG. 1) disposed inside the housing 10.

A user of the charging device 1 places an object 2 to be charged on the flat plate 4. The object 2 is a mask in the present embodiment but may be any object including a fabric article such as a mask. When the user operates the charging device 1, the flat plate 4 disposed on the upper surface of the housing 10 is charged by the voltage outputted from the output circuit disposed inside the housing 10. The charging device 1 can charge the object 2 with the charged flat plate 4.

### Experiment

Experiments (Experiments 1 to 6) performed by the present inventors to verify suitable conditions of the charging device will be explained.

### Experiment 1

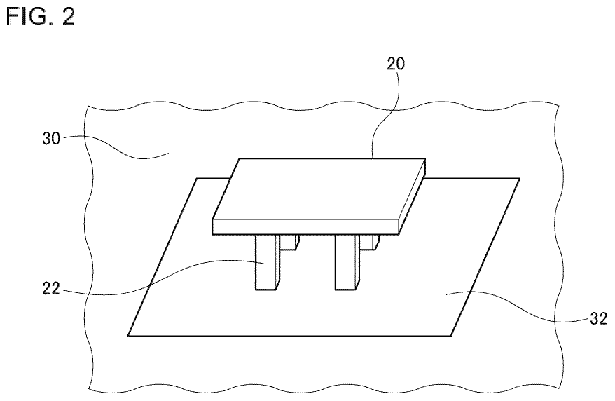

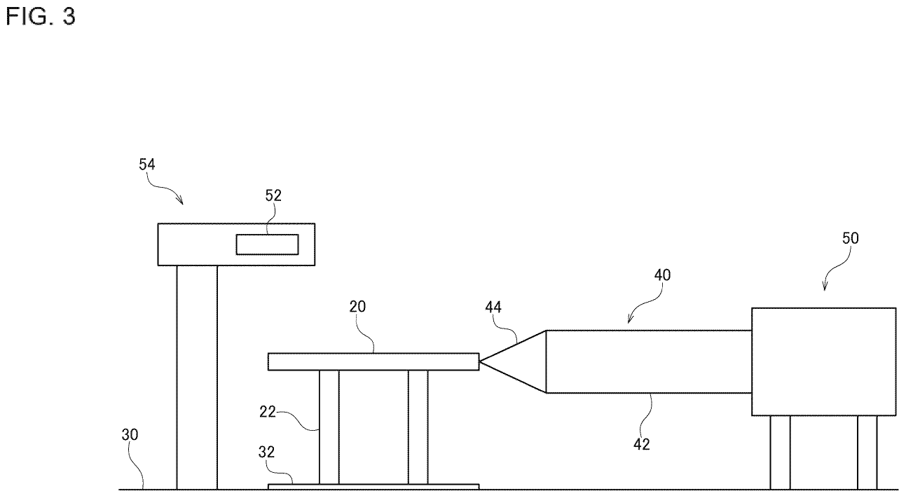

FIG. 2 and FIG. 3 are diagrams for explaining a measurement condition in Experiment 1.

As illustrated in FIG. 2, a flat plate 20 with four legs 22 was disposed on an experiment stand 30. An insulating sheet 32 is disposed between the leg 22 and the surface of the experiment stand 30. Here, the flat plate 20 is assumed as the flat plate 4 disposed on the housing 10 of the charging device 1 illustrated in FIG. 1. That is, the flat plate 20 is assumed to be used as a configuration of charging an object such as a mask.

In the present experiment, this flat plate 20 was charged using an electrostatic gun (also referred to as a “charging gun” in general) having a function of a voltage amplifying circuit, and the distribution of the charged voltage on the upper surface of the flat plate 20 was measured. Specifically, as illustrated in FIG. 3, an electrostatic gun 40 and a voltage measuring instrument 52 were disposed to measure the distribution of the charged voltage on the upper surface of the charged flat plate 20. The electrostatic gun 40 is supported by a gun support body 50 disposed on the experiment stand 30. In addition, the voltage measuring instrument 52 is supported by a measuring instrument support body 54 disposed on the experiment stand 30. The electrostatic gun 40 includes an end 44 with a sharp tip, and a housing 42 including a circuit for charging the end 44. In the present experiment, the flat plate 20 was charged by charging the tip of the electrostatic gun 40 while the tip was brought into contact with the lateral surface of the flat plate 20. Thereafter, the distribution of the charged voltage on the surface of the flat plate 20 in the charged state was measured using the voltage measuring instrument 52.

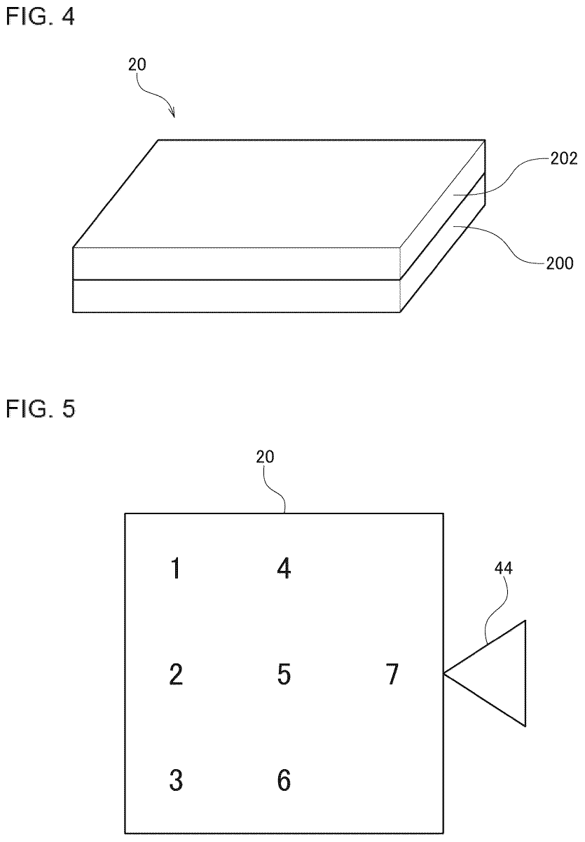

FIG. 4 is a diagram illustrating a configuration of the flat plate 20 used in the present experiment. The flat plate 20 includes a metallic plate 200 and an insulating plate 202 provided thereon. In the present experiment, the flat plate 20 was charged while the tip of the electrostatic gun 40 was brought into contact with the lateral surface of the metallic plate 200. Furthermore, in the present experiment, in addition to a case where the flat plate 20 has a two-layer structure of the metallic plate 200 and the insulating plate 202 as illustrated in FIG. 4, the measurement was also performed in a case where the flat plate is configured only by the insulating plate.

Note that, if the flat plate is configured only by a metallic plate, the metallic plate charged to a high voltage discharges electricity into the air. Assuming that this flat plate is used in the charging device illustrated in FIG. 1, it is considered that electric discharge by the charged flat plate is not preferable to the user. As in the present experiment, by configuring the flat plate to include at least the insulating plate, it is possible to suppress the flat plate from discharging electricity.

FIG. 5 is a diagram illustrating a position where a charged voltage of the flat plate 20 in a charged state is measured in the present experiment. In the present experiment, as illustrated in FIG. 5, charged voltages at positions numbered 1 to 7 were measured. Note that a triangle illustrated in FIG. 5 represents the end 44 of the electrostatic gun 40.

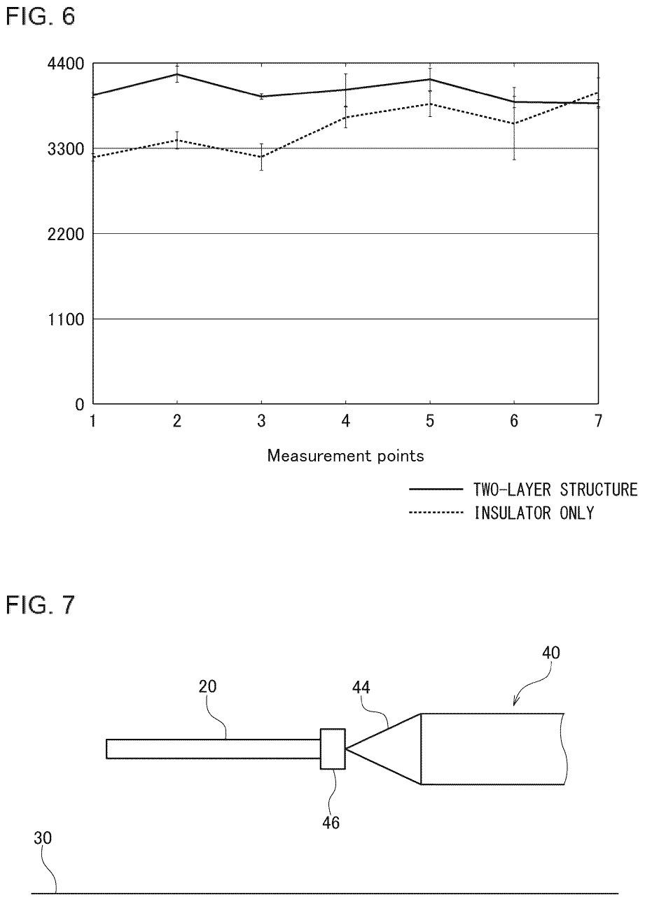

FIG. 6 is a graph illustrating measurement results in the present experiment. The horizontal axis of the graph represents measurement points, and values thereof correspond to the numbers of respective positions in the flat plate 20 illustrated in FIG. 5. In addition, the vertical axis of this graph represents charged voltages at the measurement points. Note that each value of the charged voltages is not an absolute value, but a relative value obtained by multiplying the actual value by the same coefficient. In the graph illustrated in FIG. 6, a measurement result obtained in a case where the configuration of the flat plate has a two-layer structure of an insulating plate and a metallic plate as illustrated in FIG. 4 is indicated by a solid line, whereas a measurement result obtained in a case where the configuration of the flat plate includes only the insulating plate is indicated by a broken line. As illustrated in FIG. 6, in the measurement result obtained in the case of the two-layer structure, the distribution of the charged voltage was more uniform than the measurement result obtained in the case of including only the insulating plate. It is likely that this is because the charged voltage of the insulating plate is made uniform by the metallic plate.

### Experiment 2

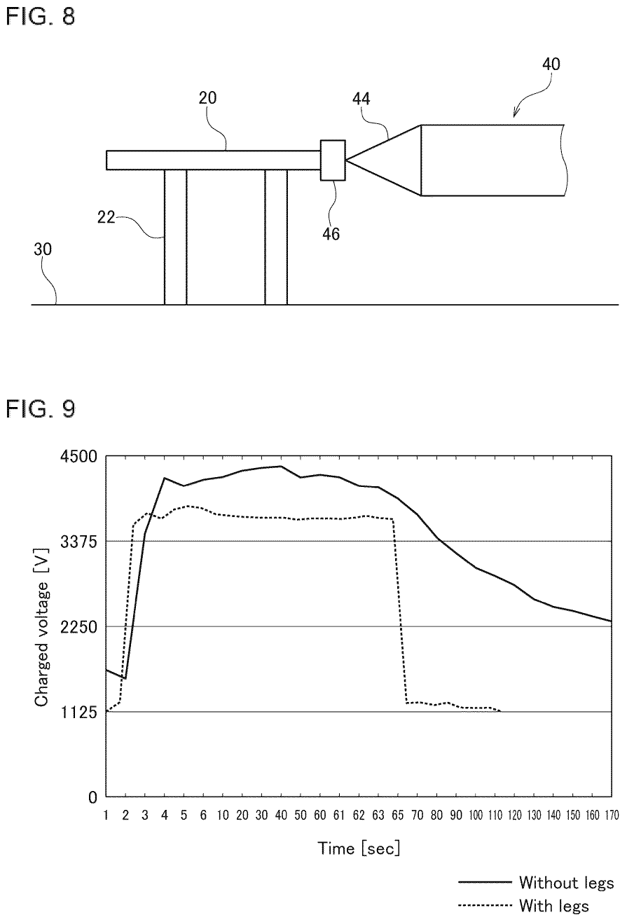

In Experiment 2, the measurement was performed under two measurement conditions. FIG. 7 and FIG. 8 are diagrams for explaining the respective measurement conditions. In Experiment 2, the voltage of the flat plate 20 is measured using the gun support body 50 and the voltage measuring instrument 52 illustrated in FIG. 1, but the gun support body 50 and the voltage measuring instrument 52 are not illustrated in FIG. 7 and FIG. 8. Here, the flat plate 20 is a flat plate having a two-layer structure of a metallic plate and an insulator.

Under a first measurement condition, as illustrated in FIG. 7, a fixing member 46 made of the insulator was provided at the tip of the end 44 of the electrostatic gun 40, and the flat plate 20 was fixed to this fixing member 46. Accordingly, the flat plate 20 is supported in midair by the tip of the electrostatic gun 40, that is, while avoiding coming into contact with any object (the experiment stand 30, for example) other than the fixing member 46. That is, the flat plate 20 is supported only by the electrostatic gun 40.

Under a second measurement condition, as illustrated in FIG. 8, similarly to FIG. 7, a fixing member was provided at the tip of the electrostatic gun 40, and the flat plate 20 is fixed to this fixing member 46. Furthermore, as illustrated FIG. 8, under the second measurement condition, four legs 22 similar to the legs 22 illustrated in FIG. 2 were provided on the lower surface of the flat plate 20, and the legs 22 were brought into direct contact with the experiment stand 30. Therefore, under the second measurement condition, the flat plate 20 is supported by the experiment stand 30 and the electrostatic gun 40.

FIG. 9 is a graph illustrating measurement results in Experiment 2. In Experiment 2, the input of the electrostatic gun 40 was turned on to charge the flat plate 20, and at a timing when a predetermined time has elapsed, the input of the electrostatic gun 40 was turned off. In FIG. 9, the charged voltage on the surface of the flat plate during a period from a timing immediately before the input of the electrostatic gun 40 was turned on until a certain period of time elapsed after the input of the electrostatic gun 40 was turned off, was measured. The horizontal axis of this graph illustrated in FIG. 9 represents the elapsed time (seconds), and the vertical axis of the graph represents the charged voltage on the surface of the flat plate 20. Note that each value of the charged voltages is not an absolute value similarly to the graph illustrated in FIG. 6.

In the graph illustrated in FIG. 9, as illustrated in FIG. 7, the measurement result obtained in a case where the flat plate 20 is supported only by the electrostatic gun 40, is indicated by a solid line. Furthermore, in this graph, as illustrated in FIG. 8, the measurement result obtained in a case where the legs 22 are provided on the flat plate and the flat plate 20 is supported by the experiment stand 30 and the electrostatic gun 40, is indicated by a broken line.

As illustrated in the graph, in all the measurement results, the charged voltage increases at a timing of 2 seconds after the input of the electrostatic gun 40 is turned on, and thus, it can be seen that the surface of the flat plate is charged. When the elapsed time reached approximately 65 seconds, the input of the electrostatic gun 40 was turned off, and consequently, the charged voltage rapidly decreased in the measurement result indicated by the broken line. It is likely that this is because the electric charge accumulated on the surface of the flat plate 20 flowed to the ground (experiment stand 30) via the legs 22. If a mask or the like is placed on the surface of the flat plate 20 to charge the mask, it is considered that electric charges in the mask also partially flow to the ground.

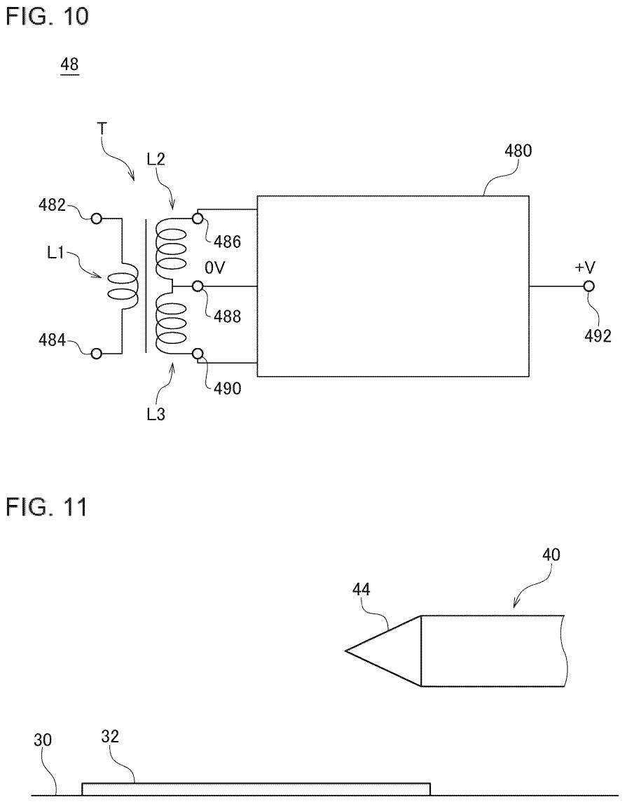

On the other hand, in the measurement result indicated by the solid line, although the charged voltage gradually decreases after the input of the electrostatic gun 40 is turned off, a rapid decrease in the charged voltage similar to that in the measurement result indicated by the broken line is suppressed. It is likely that this is because the flat plate 20 is suppressed from discharging electricity to other objects such as the experiment stand 30 as the flat plate 20 is supported only by the electrostatic gun 40. The reason why the electric discharge from the flat plate 20 as described above is suppressed will be explained with reference to FIG. 10.

FIG. 10 is a circuit diagram illustrating an output circuit 48 included in the electrostatic gun 40. The output circuit is a circuit that boosts an input voltage and outputs an output voltage. The output circuit 48 according to the present experiment transforms the input voltage inputted through input terminals 482, 484, boosts the transformed input voltage, and outputs the output voltage through an output terminal 492. The output voltage which has been outputted, is transmitted to the tip of the electrostatic gun 40, and the flat plate 20 is charged by the output voltage.

The output circuit 48 of the electrostatic gun 40 used in the present experiment includes a transformer T that transforms the input voltage, and a booster circuit 480 that boosts the input voltage transformed by the transformer T. The transformer T includes a first coil L1, a second coil L2, and a third coil L3. The first coil L2 is a primary coil in the transformer T, and an AC voltage is applied thereto through the input terminals 482, 483. The second coil L2 and the third coil L3 are secondary coils in the transformer T, and when an AC voltage is applied to the first coil L1, AC voltages corresponding to the respective numbers of windings in the first coil L1, the second coil L2, and the third coil L3 are generated at terminals 486, 488 and terminals 488, 490. This voltage is boosted by the booster circuit 480, and an output voltage is outputted through the output terminal 492.

At this time, the second coil L2 or the third coil L3 is not connected to the first coil L1. Therefore, when the input terminal 482, 484 are grounded, the terminals 486, 488 and the terminals 488, 490 are not grounded. Therefore, even after the input is turned OFF, the tip of the electrostatic gun 40 is maintained in a charged state. Accordingly, as illustrated in FIG. 9, it is considered that, in a case where the flat plate 20 was supported only by the electrostatic gun 40, the decrease in the charged voltage of the flat plate 20 was suppressed even after the input of the electrostatic gun 40 was turned off.

In the booster circuit 480, a diode and a capacitor are combined so as to boost the AC voltage generated at the terminals 486, 488 and the terminals 488, 490.

### Experiment 3

FIG. 11 is a diagram for explaining a measurement condition in Experiment 3. In Experiment 3, as illustrated in FIG. 11, the charged voltage at the tip of the electrostatic gun 40 was measured without providing a flat plate at the tip of the electrostatic gun 40. Note that, in Experiment 3, although the charged voltage is measured using a voltage measuring instrument, the voltage measuring instrument is not illustrated in FIG. 11.

In Experiment 3, after the input of the electrostatic gun 40 was turned on to charge the tip of the electrostatic gun 40, the input of the electrostatic gun 40 was turned off to measure the charged voltage of the tip of the electrostatic gun 40. In the present experiment, the charged voltage was measured while changing the distance between the tip of the electrostatic gun 40 and the experiment stand 30. Furthermore, in Experiment 3, the charged voltage was measured under the following two measurement conditions.

Under the first measurement condition, as illustrated in FIG. 11, the tip of the electrostatic gun 40 was charged in a state where the insulating sheet 32 was disposed so as to be positioned below the end 44 of the electrostatic gun 40 on the experiment stand 30, and the charged voltage thereon was measured. In addition, under the second measurement condition, the tip of the electrostatic gun 40 was charged in a state where the insulating sheet 32 was not disposed on the experiment stand 30, and the charged voltage thereon was measured.

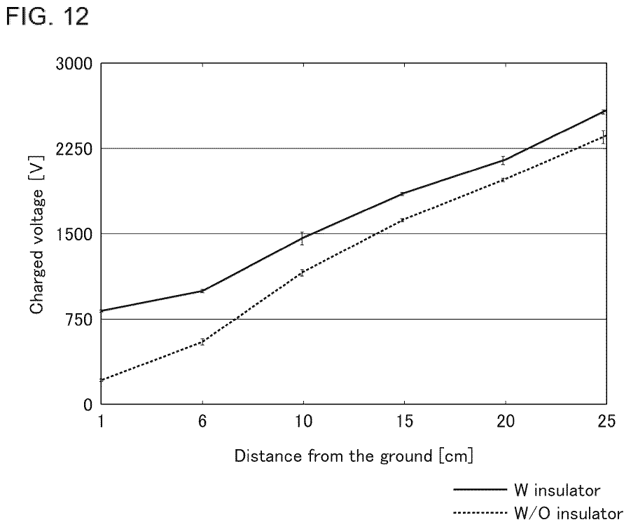

FIG. 12 is a graph illustrating measurement results in Experiment 3. In the graph illustrated in FIG. 12, the horizontal axis represents the distance between the tip of the electrostatic gun 40 and the experiment stand 30, and the vertical axis represents the charged voltage at the tip of the electrostatic gun 40. In this graph, the result of measurement with the insulating sheet 32 disposed on the experiment stand 30, is indicated by a solid line, and the result of measurement with the insulating sheet 32 not disposed on the experiment stand 30, is indicated by a broken line. Note that each value of the charged voltages is not an absolute value similarly to the graph illustrated in FIG. 6.

As illustrated in this graph, the values of the charged voltage are higher in the case where the insulating sheet 32 was disposed than in the case where the insulating sheet 32 was not disposed. It is likely that this is because the electrostatic gun 40 is suppressed from discharging electricity to the experiment stand 30 by disposing the insulating sheet 32 on the experiment stand 30.

In addition, as illustrated in this graph, in both the case where the insulating sheet 32 is disposed and the case where the insulating sheet 32 is not disposed, the value of the charged voltage increases as the distance between the tip of the electrostatic gun 40 and the experiment stand 30 increases. It is likely that this is because the electrostatic gun 40 is suppressed from discharging electricity to the experiment stand 30 as the distance between the tip of the electrostatic gun 40 and the experiment stand 30 increases.

### Experiment 4

In Experiment 4, as illustrated in FIG. 7, the flat plate 20 was fixed to the electrostatic gun 40 and supported in midair, and the charged voltage of the flat plate 20 was measured while changing the material used for the flat plate 20 to various kinds of materials. Note that each value of the charged voltages is not an absolute value similarly to the graph illustrated in FIG. 6. Here, the flat plate 20 is a flat plate having a two-layer structure of a metallic plate and an insulator. In the present experiment, a polypropylene sheet was placed on the flat plate 20 made of various kinds of materials and charged, and the charged voltage of the polypropylene sheet was measured.

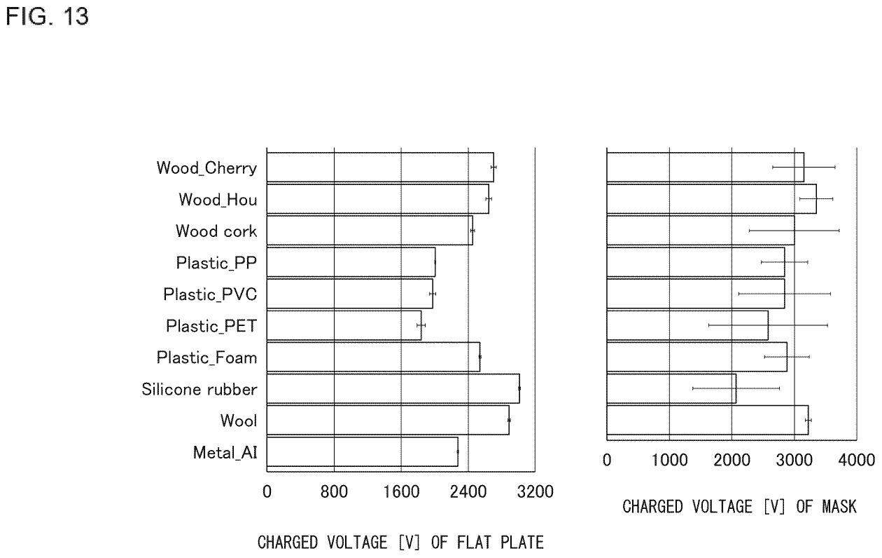

FIG. 13 is a diagram illustrating measurement results in Experiment 4. The horizontal axis represents the charged voltage, and the vertical axis represents the type of materials of the flat plate. According to the measurement result of the charged voltage of the polypropylene sheet, no big change in the charged voltage due to the variation in materials of the flat plate was observed. However, the polypropylene sheet charged with the flat plate of silicon rubber resulted in a relatively low charged voltage. In addition, according to the measurement result of the charged voltage of the flat plate 20, although a slight difference in the charged voltage was observed depending on the variation in materials of the flat plate 20, it is considered that the material of the flat plate 20 does not so significantly affect the charged voltage. However, the values became lower with plastics in general. Nevertheless, it is considered that plastics are preferable as the material of the insulator in the flat plate 20 because of a high reproducibility in manufacturing and a high output stability regardless of the surrounding environments.

### Experiment 5

Since a mask has a three-dimensional structure, there is a possibility that a contact between the mask and the flat plate 20 is not appropriate and the mask cannot be uniformly charged. The present inventors have conceived of a configuration of pressing the mask with a lid in order to uniformly charge the mask. Therefore, in Experiment 5, the charged voltage of the polypropylene sheet in a case of using a lid was measured.

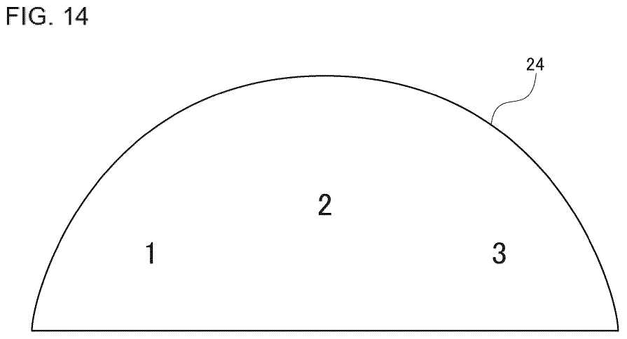

In Experiment 5, as illustrated in FIG. 7, the fixing member 46 was provided at the tip of the electrostatic gun 40, and the flat plate 20 was fixed to the fixing member 46 to support the flat plate 20 in midair. Here, the flat plate 20 is a flat plate having a two-layer structure of a metallic plate and an insulator. In Experiment 5, a polypropylene sheet was placed on the upper surface of the flat plate 20, a lid was placed thereon, and the lid pushes the polypropylene sheet to the flat plate 20. In this state, by turning on the input of the electrostatic gun 40, the flat plate 20 and the polypropylene sheet were charged. Thereafter, the input of the electrostatic gun 40 was turned off and the charged voltage of the polypropylene sheet was measured at positions numbered 1 to 3 of the polypropylene sheet 24 illustrated in FIG. 14.

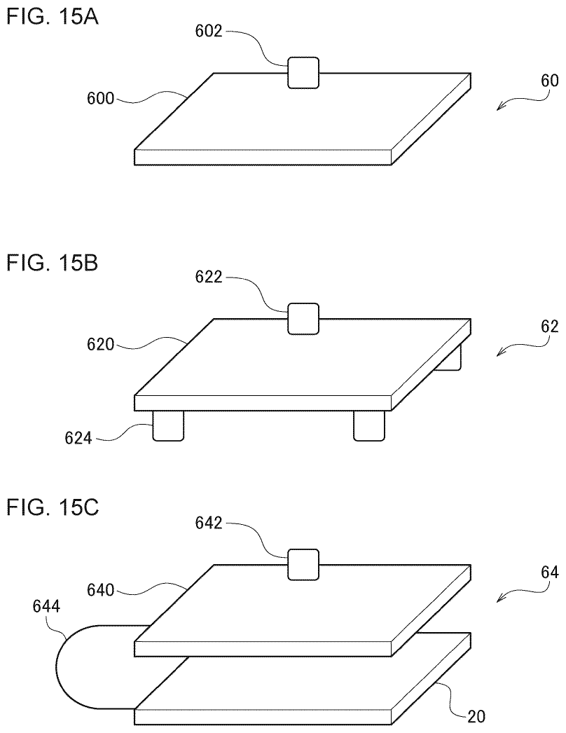

FIGS. 15A to 15C are diagrams illustrating lids used in Experiment 5, respectively. In Experiment 5, three lids illustrated in FIGS. 15A to 15C were used. A lid 60 illustrated in FIG. 15A includes a plate portion 600 made of an insulator and a handle 602 provided on an upper surface of the plate portion 600. In the measurement, the lid 60 was placed on the polypropylene sheet such that the lower surface of the plate portion 600 pushed the polypropylene sheet. A lid 62 illustrated in FIG. 15B includes a plate portion 620 made of an insulator, a handle 622 provided on the upper surface of the plate portion 620, and four leg portions 624 provided on the lower surface of the plate portion 620. In the measurement, the lid 62 was placed on the polypropylene sheet such that the four leg portions 624 pushed the polypropylene sheet and these leg portions 624 did not come into contact with the flat plate 20. A lid 64 illustrated in FIG. 15C includes a plate portion 640 made of an insulator, a handle 642 provided on the upper surface of the plate portion 640, and a connecting wire 644 connecting the plate portion 640 and the flat plate 20. The connecting wire 644 is made of a conductor material.

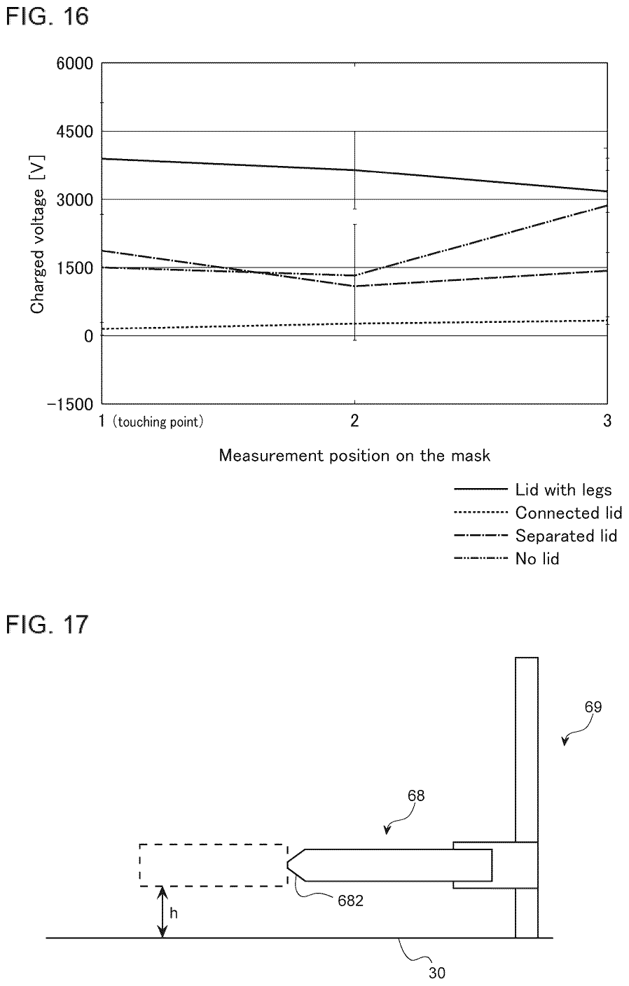

FIG. 16 is a graph illustrating measurement results in Experiment 5. The horizontal axis of the graph represents measurement points, and values thereof correspond to the numbers of respective positions illustrated in FIG. 14. In addition, the vertical axis of this graph represents charged voltages at the measurement points. In this graph, the measurement result in a case of using the lid 60 illustrated in FIG. 15A is indicated by a broken line, the measurement result in a case of using the lid 62 illustrated in FIG. 15B is indicated by a solid line, the measurement result in a case of using the lid 64 illustrated in FIG. 15C is indicated by a one-dot chain line, and the measurement result in a case of using no lid is indicated by a two-dot chain line.

In a case of using the lid 64 connected to the flat plate 20 illustrated in FIG. 15C, the charged voltage of the polypropylene sheet was the lowest. It is likely that this is because, when electric charges were about to be pushed from the flat plate 20 into the polypropylene sheet, the repulsion of electric charges occurred since electric charges charged to the same electrode are located on the opposite side, thereby lowering the charging efficiency. On the other hand, as illustrated in FIG. 16, in a case of using the lid 62 having the leg portions 624 illustrated in FIG. 15B, the polypropylene sheet could be charged to the highest charged voltage. It is likely that this is because the lid 62 pushes the polypropylene sheet to the flat plate 20 to facilitate the charging of the polypropylene sheet, and furthermore, the lid 62 does not come into contact with the flat plate 20, whereby suppressing the electric charges of the polypropylene sheet from flowing from the lid 62 to the flat plate 20.

### Experiment 6

FIG. 17 is a diagram for explaining an experimental condition in Experiment 6. In Experiment 6, a polypropylene sheet taken out from an N95 mask was used as an object to be charged. In Experiment 6, an electrostatic gun 68 was supported in midair using a support implement 69 fixed to the experiment stand 30, a flat-plate electrode was disposed at a tip 682 thereof, a polypropylene sheet was disposed thereon, and a lid was disposed on the polypropylene sheet according to experiment conditions. In the present experiment, the electrode was disposed at a position indicated by a dotted line in FIG. 17 such that the height of the electrode from the experiment stand 30 was h (=5 cm). The polypropylene sheet was put in hot water to remove static electricity, the resulting polypropylene sheet was disposed on the electrode, and in this state, the electrostatic gun 68 was turned on. Thereafter, the obtained polypropylene sheet was placed on a wood plate, and electric charges on the front side (electrode side) and the back side (side opposite to the electrode) of the polypropylene sheet were measured with an electrostatic sensor.

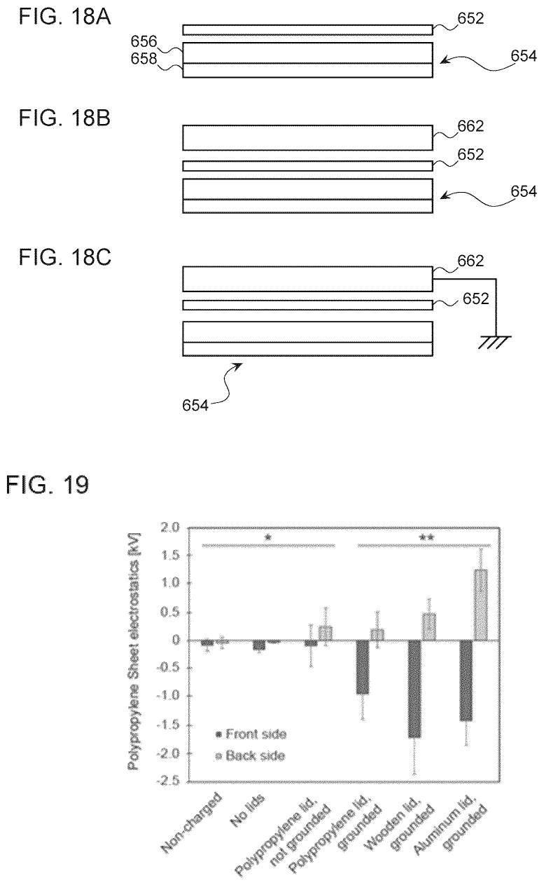

In Experiment 6, the condition of the lids disposed on the polypropylene sheet was changed. FIGS. 18A to 18C are diagrams for explaining the first to third lid conditions in Experiment 6. Under any of the lid conditions, an electrode 654 connected to the tip 682 of the electrostatic gun 68 has a two-layer structure of an aluminum sheet 658 and a polyethylene terephthalate (PET) sheet 656 disposed thereon, and a polypropylene sheet 652 was disposed on the electrode 654.

Under the first lid condition, as illustrated in FIG. 18A, an experiment was conducted without using a lid. Under the second lid condition, as illustrated in FIG. 18B, an experiment was conducted in a state where a polypropylene lid 662 that is not connected to the ground was disposed on a polypropylene sheet 652. Under the third lid condition, as illustrated in FIG. 18C, an experiment was conducted in a state where the lid 662 connected to the ground was disposed on the polypropylene sheet 652. As for the third lid condition, an experiment was conducted with the lids 662 made of three kinds of materials: polypropylene; wood; and aluminum.

FIG. 19 is a diagram illustrating measurement results according to the lid conditions. FIG. 19 illustrates results of measuring electric charges on the front side and the back side of the polypropylene sheet 652. FIG. 19 illustrates results of measurements performed: before charging (Not-charged); under the first lid condition in which no lid was used (No lids); under the second lid condition in which the lid that is not connected to the ground was used (Polypropylene lid, not grounded); and under the third lid condition in which the lid connected to the ground was used. Under the third lid condition, the lids made of three kinds of materials are used as described above, and FIG. 19 illustrates results of using a polypropylene lid (Polypropylene lid, grounded), a wooden lid (Wooden lid, grounded), and an aluminum lid (Aluminum lid, grounded).

As illustrated in FIG. 19, under both the first lid condition in which no lid is used and the second lid condition in which an electrically-floating lid (that is not connected to the ground) is used, the polypropylene sheet 652 was hardly charged (* in FIG. 19). On the other hand, it can be seen that, under the third lid condition in which the lid connected to the ground is used, the charging effect is dramatically improved as compared with the first and second lid conditions (** in FIG. 19). It is likely that this is because a larger electric field was applied to the polypropylene sheet 652 due to the presence of the lid connected to the ground.

Note that, as illustrated in FIG. 19, under the third lid condition, the influence of the material (polypropylene, wood, aluminum) of the lid connected to the ground on the charging was small. Note that, as for aluminum, the size of the lid was an important parameter. It has been found that when the lid is large, the electric discharge to the atmosphere and the electric discharge between the electrode and the lid occur at the edge, thereby providing an adverse affects on charging.

### Embodiment

FIG. 20 is an exterior drawing of a charging device 7 according to one embodiment of the present disclosure. The charging device 7 according to the present embodiment includes a housing 70, a lid portion 72, and an operation unit 74. The lid portion 72 and the operation unit 74 are connected via connectors 76, 77, and 78, and are integrally movable.

FIG. 21 is a diagram illustrating one example of a state where the charging device 7 according to the present embodiment is in use. As illustrated in FIG. 21, the user can open the lid portion 72 by pushing the operation unit 74. In this state, the user can charge a mask 8 by placing an object such as the mask 8 on the upper surface of the housing 70 and driving the charging device 7.

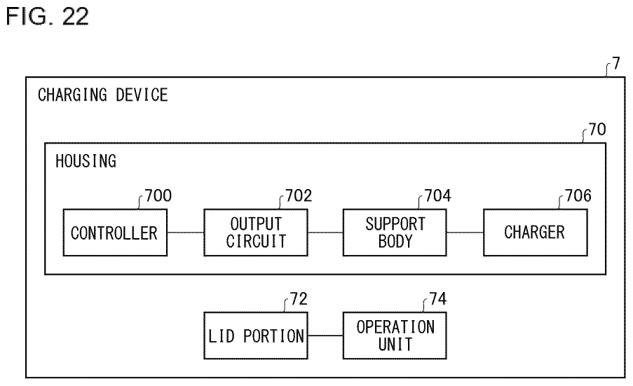

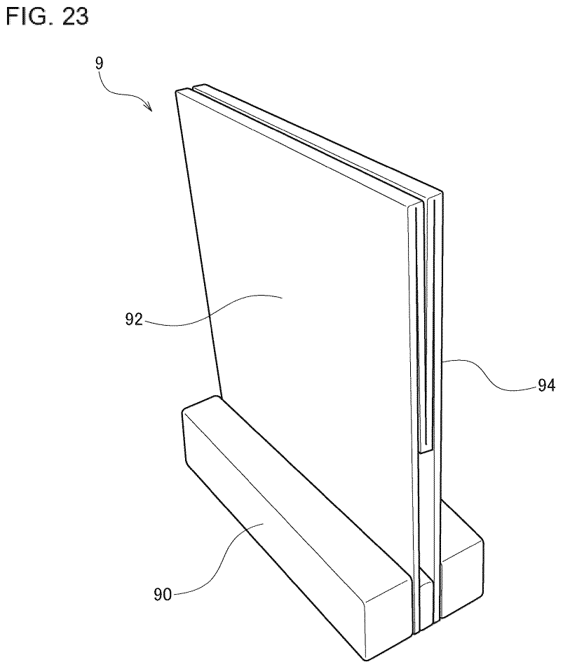

FIG. 22 is a block diagram for explaining functions of the charging device 7 according to the present embodiment. The housing 70 of the charging device 7 according to the present embodiment includes a controller 700, an output circuit 702, a support body 704, and a charger 706.

The controller 700 controls driving of the output circuit 702. Specifically, the controller 700 may include a drive circuit that inputs a voltage based on a power supply voltage supplied from a power supply (not illustrated) to the output circuit 702 and drives the output circuit 702.

The output circuit 702 is a circuit that boosts a voltage and outputs an output voltage. The output circuit 702 may have a configuration similar to that of the output circuit 48 illustrated in FIG. 10, for example. The booster circuit included in the output circuit 48 may include, for example, a voltage amplifying circuit such as a Cockcroft-Walton circuit. In this case, the input terminals 482, 484 of the output circuit 702 may be connected to the drive circuit in the controller 700, and the output terminal 492 of the output circuit 702 may be connected to the support body 704. The output circuit 702 receives an input voltage from the controller 700 through the input terminals 482, 484, transforms the input voltage in the transformer T, and boosts the transformed voltage. The output circuit 702 can also output an output voltage through the output terminal 492 and transmit the output voltage to the charger 706 via the support body 704. Note that the output circuit 702 is not limited thereto and may include various kinds of well-known boosting circuits. Furthermore, the output circuit 702 is not necessarily mounted on a structure having a gun shape such as an electrostatic gun described above and may be mounted on a structure having an arbitrary shape.

The support body 704 supports the charger 706 and can transmit the output voltage outputted from the output circuit 702 to the charger 706. Similarly to the fixing member 46 explained with reference to FIG. 7, the support body 704 may support the charger 706 in midair. Accordingly, the charger 706 which has been charged is suppressed from discharging electricity to the ground.

The charger 706 allows various kinds of objects such as a mask to be placed thereon and charges the placed object in a state of being charged by the output voltage outputted from the output circuit 702. The charger 706 may constitute the upper surface of the housing 70 on which an object is disposed. The charger 706 may have an electrode configured by various kinds of materials such as an insulator or a metal. The charger 706 may have an insulating plate to be charged by the output voltage outputted from the output circuit 702. Accordingly, electric discharge by the charger 706 which has been charged is suppressed. Furthermore, the charger 706 may also include a metallic plate disposed so as to be in contact with the insulating plate. Accordingly, it is possible to charge the insulating plate more uniformly, thereby charging the object more uniformly.

The lid portion 72 is disposed so as to cover the object, and more specifically, may be configured to push the object to the charger 706 in a state where the object is placed on the charger 706. Accordingly, the object is suppressed from being exposed at the time of charging, and the user can use the charging device 7 more safely. In addition, the lid portion 72 may be configured to push the object to the charger 706, while avoiding coming into contact with the charger 706. Accordingly, it is possible to apply a high voltage to the object while preventing the lid portion 72 and the charger 706 from becoming a short circuit.

Furthermore, the lid portion 72 may be connected at a predetermined reference potential, more specifically, may be connected to the ground. That is, the lid portion 72 may function as a grounding unit. The charger 706 charges an object in a state where the object is disposed between the lid portion 72 and the charger 706. Accordingly, it is possible to generate a larger electric field between the charger 706 and the lid portion 72, thereby facilitating charging of the object. When the object is charged, it is possible to generate a larger electric field as the space between the lid portion 72 and the charger 706 is smaller. On the other hand, when the space therebetween is too small and the contact area between the lid portion 72 and the object becomes large, electric charges of the charged object easily escape. The space between the lid portion 72 and the charger 706 may be, for example, approximately 1 cm.

In addition, the charging device 7 may further include an insulator disposed between the ground plane of the charging device 7 and the charger 706, while being separated from the charger 706. Accordingly, the charger 706 which has been charged is suppressed from discharging electricity to the ground or the like.

The configuration of the charging device 7 according to the present embodiment has been explained above. According to the charging device 7 of the present embodiment, it is possible to charge various objects such as a cloth article including a mask by the charger 706. Furthermore, by supporting the charger 706 in midair or disposing an insulator between the charger 706 and the ground plane, it is possible to suppress the charger 706 from discharging electricity and charge the object more easily.

### Modification

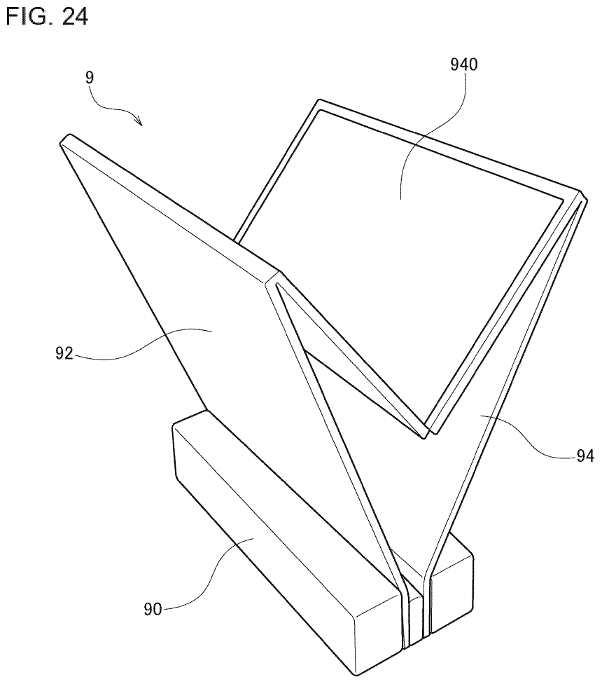

FIG. 23 is an exterior drawing of a charging device 9 according to a modification. The charging device 9 according to the modification includes a housing 90, a first flat plate 92, and a second flat plate 94. In the charging device 9 according to the modification, an object such as a mask is sandwiched between the first flat plate 92 and the second flat plate 94 so as to charge the mask in this state.

FIG. 24 is a drawing illustrating a state where the charging device 9 according to the modification is opened. Here, an internal flat plate 940 connected to the second flat plate 94 may have a function as a charger. In the state illustrated in FIG. 24, the user places an object such as a mask on the internal flat plate 940 and closes the charging device 9 as illustrated in FIG. 23. By turning on the input of the charging device 9 in this state, the user can charge the mask.

### Supplementary

The present disclosure has been explained above based on the embodiment. A person skilled in the art understands that the embodiment is an example, and various modifications can be made in terms of combinations of components and processing processes, and such modifications also fall within the scope of the present disclosure.

In the above embodiment, the example in which the object to be charged is mainly a mask has been explained. However, the object is not limited thereto and may be a mop yarn provided on a mop or a duster used as a replacement sheet for a floor cleaning tool. Static electricity is used for the mop yarn and the duster, but the static electricity decreases according to the use of these cleaning tools. By using the charging device according to the above embodiment, it is possible to reapply the static electricity which has decreased.

In a case where the mop yarn is used as the object, the configuration of the charger may be adapted to the shape of the mop yarn, and more specifically, the shape, size, and the like of the electrode constituting the charger may be adjusted to the shape of the mop yarn, if necessary. For example, the electrode may be formed into a curved surface in accordance with the shape of the mop yarn.

What is claimed is:

1. A charging device comprising:
a charger on which an object is placed; and
an output circuit structured to boost a voltage and output an output voltage, wherein
the charger charges the placed object in a state of being charged by the output voltage outputted from the output circuit.

2. The charging device according to claim 1, further comprising
a support structured to support the charger in midair, wherein
the support is disposed to transmit the output voltage outputted from the output circuit to the charger.

3. The charging device according to claim 2, further comprising
an insulator disposed between a ground plane of the charging device and the charger, while being separated from the charger.

4. The charging device according to claim 1, wherein
the charger includes an insulating plate to be charged by the output voltage outputted from the output circuit.

5. The charging device according to claim 4, wherein
the charger further includes a metallic plate disposed so as to be in contact with the insulating plate.

6. The charging device according to claim 1, wherein
the output circuit includes a transformer structured to transform an input voltage, and a booster circuit structured to boost an input voltage transformed by the transformer.

7. The charging device according to claim 1, further comprising
a lid portion structured to push the object to the charger in a state where the object is placed on the charger, while avoiding coming into contact with the charger.

8. The charging device according to claim 1, further comprising
a grounding unit connected to a ground, wherein
the charger charges the object in a state where the object is disposed between the grounding unit and the charger.
